(19) United States
(12) Patent Application Publication
(10) Pub. No.: US 2026/0268120 A1
(43) Pub. Date: Sep. 10, 2026

(54) ROBOTIC-VIEW 3D VISION LANGUAGE ACTION MODELING VIA MULTI-VIEW HEATMAP GENERATION

(71) Applicant: NVIDIA Corporation, Santa Clara, CA (US)

(72) Inventors: Ishika Singh, Los Angeles, CA (US); Stanley Thomas Birchfield, Sammamish, WA (US); Dieter Fox, Seattle, WA (US); Animesh Garg, Atlanta, GA (US); Ankit Goyal, Seattle, WA (US); Valts Blukis, Seattle, WA (US)

(21) Appl. No.: 19/069,662

(22) Filed: Mar. 4, 2025

(51) Int. Cl. G06N 3/047; B25J 9/16; G06N 3/096

(52) U.S. Cl. CPC G06N 3/047; B25J 9/163; B25J 9/1697; G06N 3/096

(57) ABSTRACT

Apparatuses, systems, and techniques are disclosed for controlling a robot to execute a task. In at least one embodiment, one or more view images, each corresponding to a predefined view of a set of predefined views, are obtained based on a plurality of input images representing observations of a scene. Based on the encoded input, a large language model (LLM) is utilized to predict a plurality of action tokens corresponding to a future state of the robot. The plurality of action tokens are decoded to generate one or more output images, each corresponding to a predefined view. The one or more output images indicate probability distributions of a location of the robot or an end-effector of the robot in a future state of the robot. A three-dimensional (3D) position corresponding to the future state of the robot is determined based on the probability distributions.

### BACKGROUND

In the field of robotics, building robust policies that enable robots to perform tasks in unseen environments is essential for real-world industrial and household applications, such as cleaning robots, sorting and packing robots, and machine tending.

Vision-Language-Action (VLA) models have recently demonstrated successful generalization to concepts unseen in robotics training data, for example, being able to manipulate previously unseen objects based on a language instruction. However, while VLA models have achieved breakthroughs in generalization for robotics, they require huge training datasets and typically accept only a single RGB image as input. As a result, despite the large amount of training data, such models are highly sensitive to different camera and robot poses and struggle to adapt to new applications.

3D-aware keyframe-based multi-task models have demonstrated the ability to learn complex robot manipulation behaviors from few demonstrations and are able to successfully generalize to novel camera poses and object placement. Such models are based on a 3D scene representation, such as a voxel map, a set of canonical orthographic views, or a point cloud. However, unlike VLA models, these 3D-aware keyframe-based multi-task models produce policies that overfit to training scenes and objects and are unable to accept instructions referring to new, previously unseen objects.

### SUMMARY

Embodiments of the present disclosure relate to robotic-view, 3D Vision-Language-Action (VLA) modeling via multi-view heatmap generation. Systems and methods are disclosed that utilizes a VLA model to process input views and predict output views based on a predefined set of views. The model predicts the robot's future states with a plurality of probabilities, represented in the multi-view output. The next state of the robot is determined from these probabilities represented in the multiple views and is used to control the movement of the robot.

### BRIEF DESCRIPTION OF THE DRAWINGS

The present systems and methods for robotic-view 3D Vision-Language-Action (VLA) modeling via multi-view heatmap generation are described in detail below with reference to the attached drawing figures, wherein:

FIG. 1A illustrates a block diagram of an example system suitable for use in implementing some embodiments of the present disclosure;

FIG. 1B illustrates a block diagram of a robot motion planning pipeline, in accordance with an embodiment;

FIG. 1C illustrates examples of task instructions and partial observations of robots in a three-dimensional (3D) scene, in accordance with an embodiment;

FIG. 2A illustrates a block diagram of a model, in accordance with an embodiment;

FIG. 2B illustrates an example prompt and an example LLM text output, in accordance with an embodiment;

FIG. 3 illustrates a flowchart of a method for controlling a robot to perform a task, in accordance with an embodiment;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to robotic-view, three-dimensional (3D) Vision-Language-Action (VLA) modeling via multi-view heatmap generation, leveraging generalization strengths of VLA models with robustness of 3D-aware policies.

In at least one embodiment, a Large-Language-Model (LLM) based system is provided. The system takes as input various types of observation data, such as posed depth and color images, and a task instruction (for example in natural language), and predicts future states of a robot to guide its movement. In at least one embodiment, the system produces a sequence of end-effector pose keyframes (represented by six degrees of freedom (6-DOF)).

In at least one embodiment, the system includes a visual data renderer, a visual encoder, an LLM, and a visual decoder. In at least one embodiment, the visual data renderer first reconstructs a 3D scene by combining observations from multiple views into a universal coordinate system, and then generates a set of two-dimensional (2D) images of predefined views from the 3D scene reconstruction. In at least one embodiment, the visual data renderer includes a point cloud renderer, which generates a point cloud as the scene reconstruction and renders a set of images of canonical orthographic views. As such, the visual data renderer produces a set of input images of orthonormal views. The visual encoder encodes the set of input images to provide a sequence of visual tokens for each orthonormal view. The sequences of visual tokens are projected into a text embedding space to provide sequences of latent embeddings, to be processed by the LLM. In at least one embodiment, an input to the LLM includes latent embeddings produced from tokenized text input (e.g., text input tokens) and latent embeddings corresponding to the visual input. Based on the input latent embeddings, the LLM predicts a set of special action tokens for conditioning the visual decoding, which capture the visual and/or semantic meaning of the input latent embeddings. The set of special action tokens are projected into a feature embedding space to be processed by the visual decoder. The visual decoder is configured to generate images of specific orthonormal views from random noise (e.g., provided as an initial noise tensor), conditioned on the set of projected special action tokens. The projected special action token corresponding to a specific orthonormal view is used to condition the visual decoder to generate an output image of that view. In at least one embodiment, the visual decoder includes an image diffusion model for generating output images of the predefined views.

In at least one embodiment, the LLM and the visual decoder (e.g., the image diffusion model) are trained end-to-end, allowing them to work jointly to produce consistent and effective predictions of future states of the robot.

Systems and methods are disclosed herein that, by incorporating LLM and diffusion model priors into a 3D-aware robot policy, such as those applied in tasks utilizing end-effector keyframes to define critical poses and movements, enable accurate prediction of a future state of the robot as a target for guiding its movement. Compared to the existing VLA models and 3D-aware keyframe-based multi-task models, this approach demonstrates improved generalization as evidenced by state-of-the-art results in unseen environments, without compromising results in seen environments.

A method is provided for controlling a robot to execute a task, which includes: generating, based on one or more view images and a text instruction describing the task, a plurality of input tokens. In at least one embodiment, each of the one or more view images corresponds to a predefined view of a set of predefined views. The method further includes: generating, by a large language model (LLM) and based on the plurality of input tokens, a plurality of action tokens, and decoding the plurality of action tokens to generate one or more output images each corresponding to a predefined view of the set of predefined views. In at least one embodiment, the one or more output images indicate probability distributions of a location of the robot or an end-effector of the robot in a future state of the robot. The method further includes determining, based on the probability distributions of the location of the robot or the end-effector in the future state of the robot, a three-dimensional (3D) position corresponding to the future state of the robot.

According to an embodiment of the method, the method further includes obtaining a plurality of input images based on observations of a scene, and obtaining, based on the plurality of input images, one or more view images each corresponding to a predefined view of a set of predefined views.

According to an embodiment of the method, the method further includes: generating a 3D reconstruction of the scene by combining the plurality of input images according to a universal coordinate system. In at least one embodiment, the plurality of input images comprises one or more depth images. In at least one embodiment, the set of view images are two-dimensional (2D) images rendered from a 3D scene reconstruction.

According to an embodiment of the method, the 3D reconstruction of the scene comprises a point cloud.

According to an embodiment of the method, the determined 3D position is a position having the highest probability in 3D space obtained from the probability distributions.

According to an embodiment of the method, the set of predefined views are a set of canonical views obtained from a 3D representation of the scene.

According to an embodiment of the method, the method further includes: generating, by one or more image encoders and based on the one or more view images, a set of image token sequences, each image token sequence corresponding to a predefined view of the set of predefined views, and projecting, by one or more projection networks, the image token sequences to text embedding space. In at least one embodiment, each image token sequence comprises one or more image tokens. In at least one embodiment, the plurality of input tokens includes the set of image token sequences.

According to an embodiment of the method, the method further includes: generating a prompt based on the text instruction describing the task, and generating a sequence of text tokens based on the prompt. In at least one embodiment, the plurality of input tokens includes the sequence of text tokens.

According to an embodiment of the method, the method further includes: generating, based on the plurality of action tokens and by one or more image decoders, one or more heatmaps as the one or more output images. In at least one embodiment, each heatmap indicates a probability distribution of a location of the robot or the end-effector in the future state of the robot in the corresponding predefined view. The method further includes combining the one or more heatmaps corresponding to the set of predefined views to produce an aggregated heatmap, and determining, based on the aggregated heatmap, a 3D position with the highest probability in a 3D space as the 3D position corresponding to the future state.

According to an embodiment of the method, the method further includes: moving the robot to the future state, obtaining a plurality of second input images based on observations of the scene, obtaining, based on the plurality of second input images, one or more second view images each corresponding to a predefined view of the set of predefined views, generating, based on the one or more second view images and the text instruction describing the task, a plurality of second input tokens, generating, by the LLM and based on the plurality of second input tokens, a plurality of second action tokens, and decoding the plurality of second action tokens to generate one or more second output images each corresponding to a predefined view of the set of predefined views. In at least one embodiment, the one or more second output images indicate second probability distributions of a location of the robot or the end-effector in a second future state of the robot. The method further includes determining, based on the second probability distributions of the location of the robot or the end-effector in the second future state of the robot, a second 3D position corresponding to the second future state of the robot.

According to an embodiment of the method, the method further includes: during training, tuning a plurality of weights in the LLM and one or more visual decoders jointly, wherein weights in one or more visual encoders are frozen.

A machine-readable medium is provided having stored thereon a set of instructions, which if performed by one or more processors, cause the one or more processors to perform the method for controlling a robot to execute a task.

A system is provided for controlling a robot to execute a task, which includes one or more processors configured to: generate, based on one or more view images and a text instruction describing the task, a plurality of input tokens. In at least one embodiment, each of the one or more view images corresponds to a predefined view of a set of predefined views. The one or more processors are further configured to: generate, by a large language model (LLM) and based on the plurality of input tokens, a plurality of action tokens, and decode the plurality of action tokens to generate one or more output images each corresponding to a predefined view of the set of predefined views. In at least one embodiment, the one or more output images indicate probability distributions of a location of the robot or an end-effector of the robot in a future state of the robot. The one or more processors are further configured to: determine, based on the probability distributions of the location of the robot or the end-effector in the future state of the robot, a three-dimensional (3D) position corresponding to the future state of the robot.

According to an embodiment of the system, the one or more processors are further configured to: obtain a plurality of input images based on observations of a scene, and obtain, based on the plurality of input images, one or more view images each corresponding to a predefined view of a set of predefined views.

According to an embodiment of the system, the one or more processors are further configured to: generate a 3D reconstruction of the scene by combining the plurality of input images according to a universal coordinate system. In at least one embodiment, the plurality of input images comprises one or more depth images. In at least one embodiment, the set of view images are two-dimensional (2D) images rendered from a 3D scene reconstruction.

According to an embodiment of the system, the 3D reconstruction of the scene comprises a point cloud.

According to an embodiment of the system, the determined 3D position is a position having the highest probability in 3D space obtained from the probability distributions.

According to an embodiment of the system, the set of predefined views are a set of canonical views obtained from a 3D representation of the scene.

According to an embodiment of the system, the one or more processors are further configured to: generate, by one or more image encoders and based on the one or more view images, a set of image token sequences, each image token sequence corresponding to a predefined view of the set of predefined views, and project, by one or more projection networks, the image token sequences to text embedding space. In at least one embodiment, each image token sequence includes one or more image tokens. In at least one embodiment, the plurality of input tokens includes the set of image token sequences.

According to an embodiment of the system, the one or more processors are further configured to: generate a prompt based on the text instruction describing the task, and generate a sequence of text tokens based on the prompt. In at least one embodiment, the plurality of input tokens includes the sequence of text tokens.

According to an embodiment of the system, the one or more processors are further configured to: generate, based on the plurality of action tokens and by one or more image decoders, one or more heatmaps as the one or more output images. In at least one embodiment, each heatmap indicates a probability distribution of a location of the robot or the end-effector in the future state of the robot in the corresponding predefined view. The one or more processors are further configured to: combine the set of heatmaps corresponding to the set of predefined views to produce an aggregated heatmap, and determine, based on the aggregated heatmap, a 3D position with the highest probability in a 3D space as the 3D position corresponding to the future state.

According to an embodiment of the system, the one or more processors are further configured to: move the robot to the future state, obtain a plurality of second input images based on observations of the scene, obtain, based on the plurality of second input images, one or more second view images each corresponding to a predefined view of the set of predefined views, generate, based on the one or more second view images and the text instruction describing the task, a plurality of second input tokens, generate, by the LLM and based on the plurality of second input tokens, a plurality of second action tokens, and decode the plurality of second action tokens to generate one or more second output images each corresponding to a predefined view of the set of predefined views. In at least one embodiment, the one or more second output images indicate second probability distributions of a location of the robot or the end-effector in a second future state of the robot. The one or more processors are further configured to: determine, based on the second probability distributions of the location of the robot or the end-effector in the second future state of the robot, a second 3D position corresponding to the second future state of the robot.

According to an embodiment of the system, the one or more processors are further configured to: during training, tune a plurality of weights in the LLM and one or more visual decoders jointly, wherein weights in one or more visual encoders are frozen.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

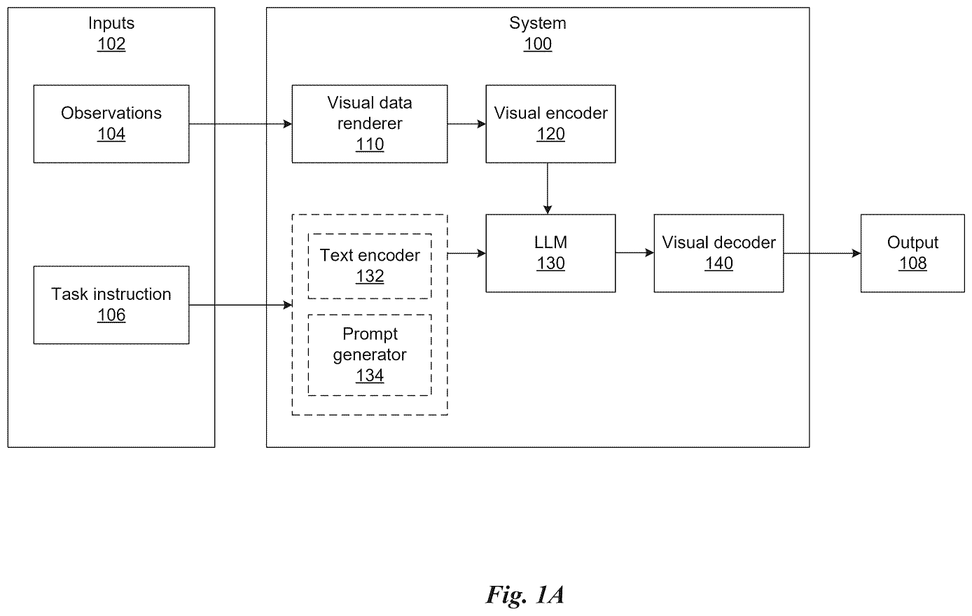

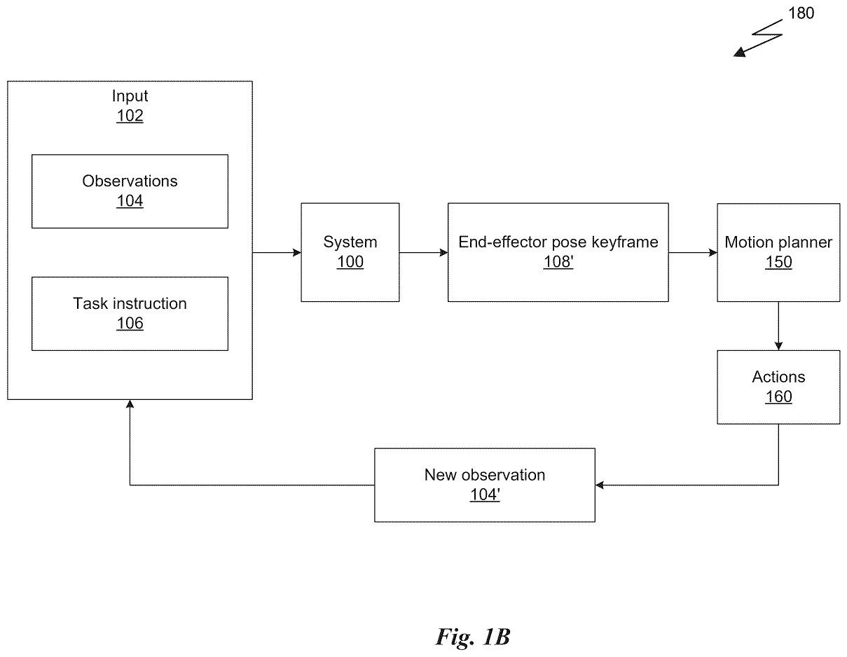

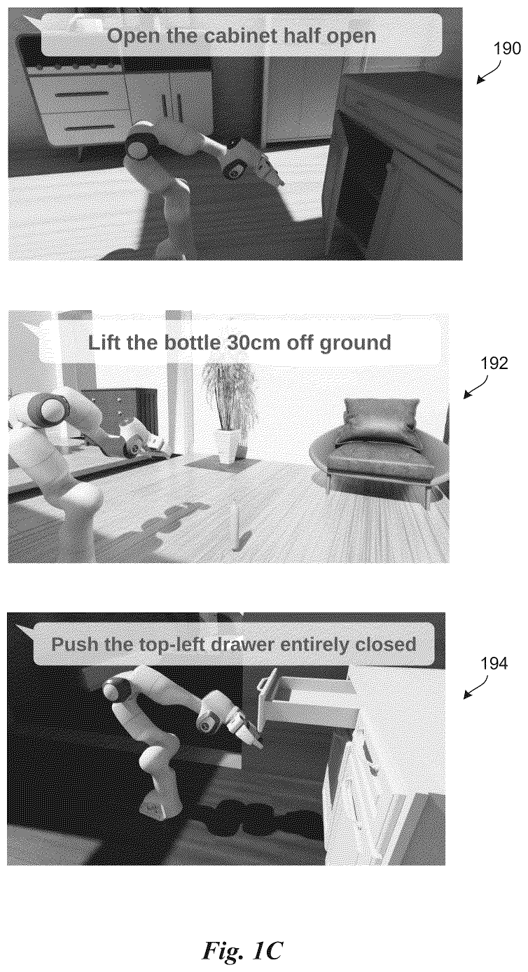

FIG. 1A illustrates a block diagram of an example system 100 suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 100 is within the scope and spirit of embodiments of the present disclosure.

The system 100 includes a visual data renderer 110, a visual encoder 120, a large language model (LLM) 130, and a visual decoder 140. In at least one embodiment, the system 100 is implemented in a robotic system/device, such as a robot, robotic arm, or any other suitable type of system/device. The system 100 can be integrated into a robotic motion planning pipeline, where it assists in controlling the motion of the robot. The system receives input 102 and generates output 108. In at least one embodiment, the output 108 provides a future state of the robot to guide the robot's next movement. In at least one embodiment, the output 108 provides one or more end-effector pose keyframes 108′ to represent the future state of the robot.

The input 102 includes observations 104 and a task instruction 106. In various embodiments, the observations 104 include visual data, for example images, videos, and/or other types of visual representations, such as symbolic representations, voxel grids, point clouds, heatmaps, or texture maps. For example, symbolic representations may include two-dimensional (2D) schematics or annotated diagrams, while voxel grids can capture volumetric data used in three-dimensional (3D) modeling and simulations.

In at least one embodiment, the visual data provides color and/or depth information representing the context in a scene (e.g., a 3D workspace). For example, in the context of robotic manipulation, the scene may include a table with various objects, and the visual data may provide color (e.g., red-green-blue (RGB) data) and depth data for the objects and their spatial arrangement.

In at least one embodiment, the visual data is associated with different perspectives, such as various viewing or shooting angles. The perspective-specific data can be provided alongside the visual data. For example, one or more images (or video frames) may include metadata indicating the intrinsic parameters (e.g., focal length, sensor dimensions) and/or extrinsic parameters (e.g., camera position, orientation) of a corresponding image acquisition device (e.g., a camera).

The visual data renderer 110 processes the received observations 104 to generate a set of unified views for subsequent processing by the system 100. For example, the set of unified views encompass the top, left, and front views of an object or a scene. These views can be arranged together in a way that they align with each other to show different perspectives of the same object/scene.

In at least one embodiment, the visual data renderer 110 generates the set of unified views based on visual data (e.g., including multiple images of various views) that have been aligned within a universal coordinate system. For example, the visual data renderer 110 obtains a plurality of points from each of the input images (e.g., RGBD images from the observations 104) and aligns the points using their perspective-specific information. This alignment allows the combination of points from various views to generate a reconstructed representation of the 3D scene within a single coordinate system.

In at least one embodiment, the visual data renderer 110 projects visual data from various views into a point cloud in a canonical workspace. Subsequently, the visual data renderer 110 generates a set of 2D images representing canonical views based on the point cloud in the canonical workspace. The canonical views referred to standardized viewpoints, such as front view (looking along the Y-axis), left view (looking along the X-axis), top view (looking down along the Z-axis).

The visual encoder 120 encodes the set of images provided by the visual data renderer 110 to generate sequences of visual tokens. Each visual token sequence is associated with a canonical view. For example, the visual encoder 120 generates a first sequence of visual tokens corresponding to the front view, a second sequence of visual tokens corresponding to the left view, and a third sequence of visual tokens corresponding to the top view. Each visual token sequence includes one or more visual tokens, where each visual token represents embedded visual features extracted from the corresponding image of a canonical view.

In at least one embodiment, the visual encoder 120 encodes a front view image, a left view image, and a top view image provided by the visual data renderer 110. Each of the front, left, and top images is segmented into a plurality of image patches, with each patch defined by predefined pixel dimensions, such as height and width. The visual encoder 120 encodes the plurality of image patches from the corresponding input image of a canonical view to generate a sequence of visual tokens for that view. For example, each visual token corresponds to an individual image patch and is encoded with its respective positional information within the image. In at least one embodiment, the visual encoder 120 includes a plurality of visual encoders, each configured to encode an image of a canonical view to provide a sequence of visual tokens. For example, three visual encoder 120 are implemented to separately encode images of the front, left, and top views, generating three corresponding sequence of visual tokens.

In at least one embodiment, the system 100 includes a first visual projector, which is integrated into or coupled with the visual encoder 120. The first visual projector is used to align the sequences of visual token from the feature embedding space associated with the visual encoder 120 to text embedding space associated with the LLM 130. For example, the first visual projector produces latent embeddings in the text embedding space based on the sequences of visual tokens.

The task instruction 106 describes a specific task for the system 100. The task may be a quasi-static manipulation task, a category that encompasses a wide variety of actions, such as pick-and-place, opening and closing doors, cabinets and containers, manipulating buttons, valves or switches, and other similar tasks. The task instruction 106 can take various forms, including text, audio data, or other suitable modalities.

In at least one embodiment, the system 100 receives a task instruction 106 as input, provided in the form of text. The system 100 utilizes a text encoder 132, such as a tokenizer, to process the task instruction 106 and generate a sequence of text tokens. In at least one embodiment, the system 100 processes the task instruction 106 using a prompt generator 134. For example, the prompt generator 134 utilizes a predefined question and answer format to generate a prompt based on information provided in the task instruction 106. In at least one embodiment, the prompt generator 134 predefines a format for the output 108. For example, the prompt generator 134 instructs the LLM 130 to provided text output that includes a position vector, a rotation vector, and a gripper open/close status indicator, formatted in predefined structures.

In at least one embodiment, the text encoder 132 generates the sequence of text tokens based on the task instruction 106 and/or the prompt provided by the prompt generator 134. The text encoder 132 and the prompt generator 134 can be combined into a single functional module or implemented as separate modules.

In at least one embodiment, the LLM 130 receives latent embeddings in the text embedding space, which correspond to the sequence of visual token sequences provided by the visual encoder 120 and the sequence of text tokens from the text encoder 132 and/or the prompt from the prompt generator 134. Based on the input, the LLM 130 predicts one or more future states for the robot (e.g., its end-effector), guiding its movement toward completing the task. In at least one embodiment, the LLM 130 predicts a set of special action tokens, which can be used during the decoding process to provide visual representation of the future states for the robot. In at least one embodiment, the system 100 utilizes predictions from the LLM 130 to provide the next keyframe representing a specific future state of the end-effector.

The concept of keyframes refers to specific time instances sampled from a continuous trajectory or sequence, often used in robotic control techniques to represent critical moments or configurations that guide the robot's motion planning and task execution. These keyframes help in discretizing the robot's continuous motion, enabling precise control and coordination during complex tasks.

The LLM 130 predicts information corresponding to a future state of the robot. In at least one embodiment, the information includes a predicted state for the end-effector and a set of special action tokens. In at least one embodiment, the predicted state includes a position vector, a rotation vector, and an indicator indicating the open/close state of the end-effector (e.g., a gripper). The set of special action tokens provide textual information that describes visual and/or semantic configurations that can be used to guide the corresponding decoder(s) to generate visual data (e.g., heatmap images) in the corresponding canonical views.

In at least one embodiment, the system 100 includes a second visual projector, which is integrated into or coupled with the visual decoder 140. The second visual projector is used to project the action tokens from the text embedding space associated with the LLM 130 to the feature embedding space associated with the visual decoder 140.

In at least one embodiment, the first and/or the second visual projector include a Multilayer Perceptron (MLP) layer trained to project the visual tokens from the feature embedding space to the text embedding space or from the text embedding space to the feature embedding space.

The visual decoder 140 decodes the set of action tokens to generate visual data representing a future of the robot. The set of action tokens each correspond to a predefined view (e.g., a front, left, or top view), and the set of action tokens can be provided as one or more sequences of action tokens, where each token in a respective sequence corresponds to a respective view of the set of views. In at least one embodiment, the visual decoder 140 includes an image diffusion model, which is used to generate an image of a specific canonical view based on an action token (or a sequence of action tokens) corresponding to that view. The visual decoder 140 generates a set of images based on the plurality of action tokens provided by the LLM 130. In at least one embodiment, the visual decoder 140 includes multiple visual decoders configured to process different action tokens (or different sequences of action tokens) separately. The number of visual decoders corresponds to the predefined number of views. For example, three visual decoders can be implemented to decode three action tokens (or sequences of action tokens), generating images for the front, left, and top views.

The action tokens represent latent embeddings generated by the LLM 130 corresponding to the input visual tokens. In at least one embodiment, the action tokens indicate visual and/or semantic configurations that can be used to guide the corresponding decoder(s) to generate visual data (e.g., heatmap images) in the corresponding predefined views (e.g., canonical views). The set of images provided by the visual decoder 140 correspond to the set of predefined views defined for the input images.

In at least one embodiment, the visual decoder 140 generates the set of images based on the set of action tokens from the LLM 130 and the information from the visual encoder 120. For example, the sequences of visual tokens provided by the visual encoder 120 and the action tokens provided by the LLM 130 (that are projected into the feature embedding space) can be combined (e.g., concatenated) to form one or more conditioning signals to the visual decoder 140 to guide the image generating process. In at least one embodiment, the visual decoder 140 receives an initialized latent (e.g., a random noise tensor) as input and applies the one or more conditioning signals to denoise the latent to eventually generate an output image of a specific view.

In at least one embodiment, the system 100 (e.g., the visual decoder 140) generates a set of composite images, with each composite image created based on an input image of a canonical view (provided by the visual data renderer 110) and an indicator representing the predicted future state of the robot (or the end-effector) for that view. In at least one embodiment, the visual decoder 140 first generates a representation (e.g., a heatmap) indicating a probability distribution of the future state within the scene at each canonical view. The system 100 (e.g., the visual decoder 140) then infers a 3D position corresponding to the future state with the highest probability by evaluating the probability distributions from the set of canonical views jointly. The system 100 utilizes the inferred 3D position to provide the indicator displayed in the composite image.

In at least one embodiment, the system 100 generates an end-effector pose keyframe based on the set of images provided by the visual decoder 140 and text output from the LLM 130 (e.g., the position vector, the rotation vector, and/or the gripper status indicator).

FIG. 1B illustrates a block diagram of a robot motion planning pipeline 180, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the pipeline 180 is within the scope and spirit of embodiments of the present disclosure.

In at least one embodiment, the pipeline 180 utilizes the system 100 to predict a future state of the robot, such as an end-effector pose keyframe 108′, based on input 102 including observations 104 and a task instruction 106.

The pipeline 180 utilizes a motion planner 150 to predict a sequence of actions 160 to move the robot (e.g., the end-effector) from the current state (e.g., corresponding to the observations 104) to the predicted future state corresponding to the end-effector pose keyframe 108′. Upon completion of the actions 160, the pipeline 180 obtains new observations 104′, which form new input to the system 100 to predict the next future state. The pipeline 180 can be continuously executed until the task indicated by the task instruction 106 is completed.

FIG. 1C illustrates examples of task instructions (in text) and partial observations of robots in a 3D scene (e.g., a workspace). Images 190, 192, and 194 each show an instruction and a third-person view of the robot to perform different tasks. For example, image 190 shows a robot arm placed in an indoor environment with cabinets, and the task instruction is to “open the cabinet half open.” Image 192 shows a robot arm placed in an indoor environment with a bottle on the ground, and the task instruction is to “lift the bottle 30 cm off the ground.” Image 194 shows a robot arm placed in an indoor environment with a cabinet containing multiple drawers, and the task instruction is to “push the top-left drawer entirely closed.”

In at least one embodiment, a model implementing the system 100 is trained using dataset that includes various task types, such as those shown in FIG. 1C. Additionally, the tasks in various types are designed with variations, such as different objects and their placements, different scenes, and different instruction variations.

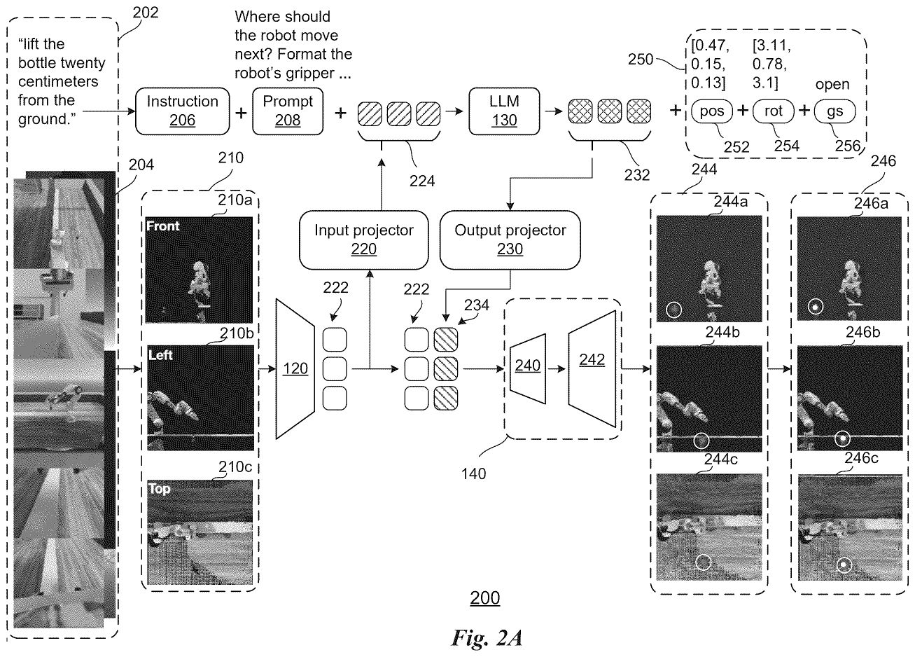

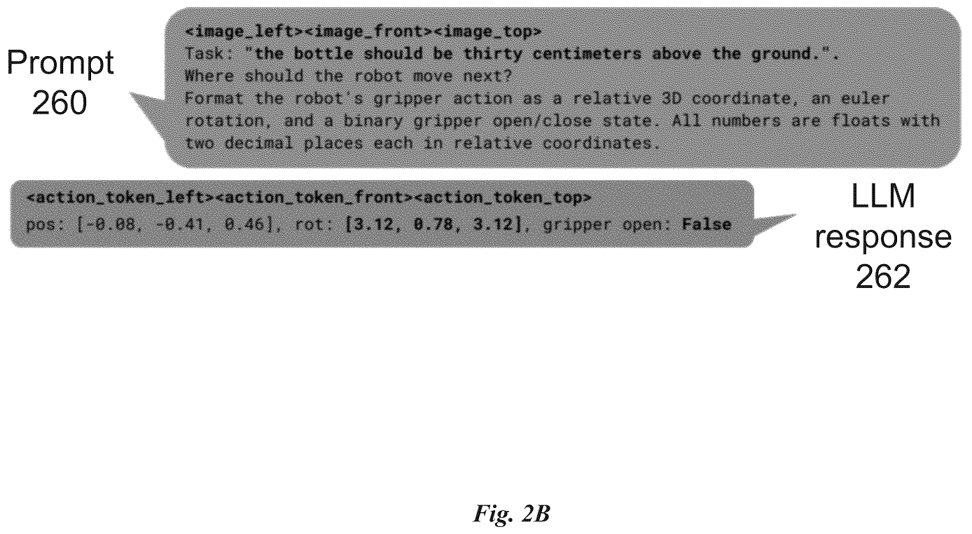

FIG. 2A illustrates a block diagram of a model 200, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the model 200 is within the scope and spirit of embodiments of the present disclosure. The model 200 is an example embodiment of the system 100.

The input 202 to the model 200 includes a task instruction 206 and multiple RGB-D images 204 of a scene. The RGB-D images refer to images and/or video frames that include both color (RGB) and depth (D) pixel information. In this example, the task instruction 206 is to “lift the bottle twenty centimeters from the ground,” provided in text form.

The model 200 generates a prompt 208 based on the task instruction 206, utilizing, for example, the prompt generator 134 of the system 100.

The model 200 processes the RGB-D images 204 of the scene to provide a set of orthographic (or orthonormal) RGB views. For example, the model 200 establishes a point cloud from the input visual data (e.g., RGB-D images 204) and re-projects the point cloud to orthographic projections (or orthographic RGB views), utilizing, for example, the visual data renderer 110 of the system 100. The orthographic projections may include a set of canonical views 210, for example in the front, left, and top views (e.g., images 210a, 210b, and 210c, respectively).

In at least one embodiment, each observation (e.g., an RGB-D image 204) is represented by a set of parameters {Iₖ, Dₖ, Pₖ, Kₖ}, where Iₖ represents the k^{th} input image, Dₖ represents depth information for the k^{th} input image, Pₖ represents a camera pose corresponding to the camera that captures the k^{th} input image, and Kₖ represents the intrinsics of the respective camera. The model 200 computes a 3D representation (e.g., point cloud, voxel grid, 3D Gaussians, etc.) for the k^{th} input view/image, which is denoted as: Cₖ∈ [symbol] . In at least one embodiment, the 3D representation for the k^{th} input image includes N points, where N can be an integer as large as the number of pixels in the k^{th} input image that have valid depth measurements. The model 200 generates K 3D representations corresponding to the K input images. The model 200 projects each 3D representation (Cₖ) into a world reference frame, where the world reference frame corresponds to a universal coordinate system. Then, the model 200 computes an aggregated 3D representation as:

$$C = {⋃}_{k - 1}^{K} {C}_{k} .$$

The set of canonical views 210 output from the visual data renderer 110 is defined in relation to a set of canonical cameras. In at least one embodiment, a set of m canonical cameras is defined as

$${\{ {P}_{i}^{c} , {K}_{i}^{c} , {f}_{i}^{c} \}}_{i = 1 , … , m} ,$$

where each

$${P}_{i}^{c}$$

represents a camera pose,

$${K}_{i}^{c}$$

represents a set of camera intrinsics, and

$${f}_{i}^{c}$$

is a flag indicating whether the camera is perspective or orthographic. The model 200 then renders the 3D representation using a 3D representation renderer (e.g., a point cloud renderer) to obtain an RGB image (e.g., image 210a, 210b, or 210c) for each camera (i) as:

$${I}_{i}^{c} = RENDER ( C , {P}_{i}^{c} , {K}_{i}^{c} , {f}_{i}^{c} , {splat}_{s i z e} , {bg}_{c o l o r} , w , h ) \qquad ( Eq . 1 )$$

$$where {I}_{i}^{c} ∈ {ℝ}^{h \times w \times 3}$$

is the output RGB image (e.g., image 210a, 210b, or 210c), splat_size is a parameter defining the physical size of each point, bg_color is the background color at pixels where no points are observed, and (w, h) is the pixel size of the output RGB image in width and height.

It will be noted that any suitable types of 3D representations, including point clouds, voxel grid, and 3D Gaussians, can be used, provided that the 3D representations can be reconstructed from the canonical views.

The orthographical (or orthonormal) views, such as the canonical views 210, are fed into one or more visual encoders (e.g., the visual encoder 120 of the system 100) to derive a set of patch embeddings. For example, the visual encoder 120 generates a plurality of patches with a predefined patch size (in pixels) from each input image. Then, the visual encoder 120 encodes the plurality of image patches to produce the set of patch embeddings for the corresponding input image, with each patch embedding corresponding to an image patch. In at least one embodiment, a patch embedding is represented by a vector and referred to as a visual token. The visual encoder 120 produces a sequence of visual tokens for each input image of a specific view. In this example, the visual encoder 120 produces three sequences of image tokens 222 based on the input images of the front, left, and top views.

The model 200 projects the patch embeddings (e.g., also referred to as first image token sequences 222) to the LLM latent space (e.g., the text embedding space associated with the LLM 130 of the system 100), using an input projector 220. The patch embeddings corresponding to each canonical view 210 are represented by a sequence of first image tokens 222 embedded in the text embedding space. The visual encoder 120 produces three sequences of first image tokens 222 associated with the set of canonical views 210. Each sequence of first image tokens 222 is projected into latent embeddings 224 in the text embedding space of the LLM 130.

The latent embeddings 224 corresponding to the set of canonical views 210 are concatenated with latent embeddings (produced based on the task instruction 206 and the prompt 208) to form an input to the LLM 130. In at least one embodiment, the task instruction 206 and/or the prompt 208 are tokenized, utilizing, for example, the text encoder 132 of the system 100 to produce a sequence of text tokens. The sequence of text tokens are embedded to produce latent embeddings corresponding to the text input. The prompt 208 guides the LLM 130 in understanding, reasoning, and predicting the next end-effector state, as well as instructing on how to format an output 250.

In at least one embodiment, the output 250 of the LLM 130 includes a set of first action tokens 232 and text output. The text output includes various parameters in a predefined format to describe the predicted status of the robot (or its end-effector). For example, the text output includes a 3D position vector 252, a 3D rotation vector 254, and a one-bit indicator that represents a gripper status (denoted as “gs”) 256 as either open or closed.

The first action tokens 232 are latent embeddings corresponding to each of the orthonormal views. The first action tokens 232 can be parsed into a number of first action tokens (or a number of sequences of first action tokens), each first action token (or sequence of first action tokens) corresponding to a specific orthonormal view. The first action tokens (or sequences) 232 are projected from the text embedding space to the feature embedding space by the output projector 230. The action tokens output from the output projector 230 are referred to as the second action tokens (or sequences of second action tokens) 234.

The second action tokens 234 are used to condition one or more visual decoders (e.g., the visual decoder 140 of the system 100) for generating predictions in visual representations. For example, each second action token (or sequence of second action tokens) is used to condition a visual decoder for generating a visual representation (e.g., heatmap) in a specific canonical view.

The visual decoder 140 includes one or more networks configured to decode and generate visual information based on the input data. In one example, as shown in FIG. 2A, the visual decoder 140 includes a first decoder 240 and a second decoder 242, which are sequentially connected. For example, the first decoder 240 can be an image diffusion model, while the second decoder 242 can be a stochastic discrete variational autoencoder (SD-VAE) decoder. During training, the weights of the image diffusion model may be trained jointly with the other networks in the model, while weights of the SD-VAE decoder may remain frozen.

In at least one embodiment, the visual decoder 140 produces a set of heatmaps 244 includes a heatmap 244a in the front view, a heatmap 244b in the left view, and a heatmap 244c in the top view. The set of heatmaps 244 indicate predictions corresponding to a next end-effector position. In at least one embodiment, each heatmap represents a probability distribution of the center of the gripper's position within the given view. The model 200 can infer the most likely 3D position by evaluating the set of heatmaps 244 jointly.

In at least one embodiment, the canonical views

$$( {\{ {I}_{i}^{c} \}}_{i = 1 , … , m} )$$

are processed by m image encoders in the model 200. For example, the visual encoder 120 of the system 100 is implemented as m image encoders in the model 200. Each canonical view

$$( {I}_{i}^{c} )$$

is processed by a corresponding image encoder to obtain an image embedding (denoted as classification token, or CLS token) and a sequence of image patch embeddings:

$${e}_{C L S}^{C} , {e}_{1}^{C} , … , {e}_{n}^{c} = VisualEncoder ( {I}_{i}^{c} ) . \qquad ( Eq . 2 )$$

The image embedding and the sequence of image patch embeddings form the first visual token sequence (e.g., represented by one block in 222).

The model 200 utilizes an input projection neural network (e.g., the first visual projector in the system 100, and/or the input projector 220) to map each embedding into the LLM input space (e.g., the text embedding space corresponding to the LLM 130) to obtain a set of tokens:

$${t}_{x}^{c} = InputProjection ( {e}_{x}^{c} ) , x ∈ \{ C LS , 1 , … n \} . \qquad ( Eq . 3 )$$

In at least one embodiment, the input projection neural network includes a liner layer, such as an MLP layer. The set of tokens

$$( {t}_{x}^{c} )$$

are referred to as the latent embeddings 224.

The input sequence to the LLM 130 includes the following sequence of tokens:

$$input = 〈 Prompt ( l ) , {t}_{C L S}^{1} , {t}_{1}^{1} , … , {t}_{n}^{1} , {t}_{C L S}^{2} , {t}_{1}^{2} , … , {t}_{n}^{2} , {t}_{C L S}^{3} , {t}_{1}^{3} , … , {t}_{n}^{3} 〉 \qquad ( Eq . 4 )$$

where Prompt(l) is a function (e.g., implemented in the prompt generator 134 in the system 100) that constructs a prompt for the instruction l and tokenizes it in a way compatible with the LLM 130. For example, the function Prompt(l) outputs a sequence of text tokens for the constructed prompt based on the task instruction l 206.

FIG. 2B illustrates an example prompt 260 and an example LLM text output 262, in accordance with an embodiment. This example shows a prompt question and answer format used for generating the prompt 260 based on an input task instruction. Bold letters in the prompt 260 indicate provided inputs from the task instruction. Bold letters in the LLM text output 262 indicate predicted outputs (e.g., text output included in the output 108) provided by the LLM 130. Angle brackets indicate special token sequences, such as the second visual token sequences (as input to the LLM 130) and the first action token sequences (as output from the LLM 130), as illustrated in FIG. 2A.

Referring back to FIG. 2A, an input sequence to the LLM 130 is formed by concatenating the latent embeddings 224 and the text token sequence encoded from the prompt 208. The input sequence is fed into the LLM 130 to produce an output sequence as:

$$output = generate ( LLM , input ) . \qquad ( Eq . 5 )$$

The output sequence includes a set of first action tokens 232. In at least one embodiment, each block indicated by 232 represents a sequence of first action tokens. In at least one embodiment, the output sequence is of the format:

$$output = 〈 {t}_{a}^{1} , {t}_{a}^{2} , {t}_{a}^{3} , {t}_{1}^{o} , {t}_{2}^{o} , … , {t}_{j}^{o} 〉 , \qquad ( Eq . 6 )$$

$$where {t}_{a}^{( \cdot )}$$

are action tokens corresponding to each of the canonical views, and

$${t}_{( \cdot )}^{o}$$

are the text tokens that represent the next gripper pose numerically in text.

In at least one embodiment, the raw output sequence from the LLM 130 can be of different format and contain additional text, such as text like “the next robot action is: . . . ”, along with the information described above.

In at least one embodiment, the model 200 applies a suitable function, such as REGEX parsing (using regular expressions to analyze, match, and manipulate strings of text), to extract, from the text (output of the LLM 130), the gripper position vector (p^{text}), the orientation/rotation vector (ω^{text}), and the open/close state (g^{text}). In certain embodiments, the gripper position extracted from the text, such as the gripper position vector (p^{text}), serves as an alternative gripper position output to the one inferred from the set of heatmaps. The text-based gripper position can be used as a baseline for evaluating the accuracy of the inferred gripper position. Additionally and/or alternatively, it can serve as a fallback result when an inferred result is unavailable or has a confidence level below a certain threshold.

Successful robot manipulation, such as picking objects or grabbing drawer handles, requires very precise end-effector position predictions. The LLM 130 of the model 200 produces the next gripper pose in text and the predictions tend to be generally correct. Additionally, the model 200 obtains more accurate position predictions by decoding the action tokens to heatmaps and inferring the next gripper position by aggregating the heatmaps across the canonical views.

In at least one embodiment, the model 200 projects, through output projector 230, the first action tokens back to the feature embedding space (e.g., corresponding to the visual decoder(s) 140) as:

$${e}_{a}^{c} = OutputProjection ( {t}_{a}^{c} ) , c ∈ \{ 1 , … , m \} . \qquad ( Eq . 7 )$$

Each embedding

$$( {e}_{a}^{c} )$$

(referred to as the second action token) is used to condition an image generation network (e.g., in the visual decoder 140) to generate an RGB image of a heatmap:

$${H}^{c} = ImageGenerator ( {e}_{a}^{c} ) , c ∈ \{ 1 , … , m \} , \qquad ( Eq . 8 )$$

where H^{c}∈{ [symbol] } is a heatmap that highlights probabilities of the gripper position corresponding to a sequence of action tokens (e.g., a second action token sequence). Each heatmap is aligned with one of the canonical input views. In at least one embodiment, the visual decoder 140(s) of the system 100 includes m image generation networks corresponding to m canonical views.

In at least one embodiment, each heatmap is represented by an all-black image, with one channel (e.g., one of the color channels of a RGB image) used to indicate a Gaussian distribution centered around the gripper position.

In at least one embodiment, each heatmap is represented by an RGB image that is a reconstruction of the input image (e.g., the image 210a, 210b, or 210c), with a Gaussian distribution overlaid on one of the channels (e.g., the color channels of the RGB image).

As shown in FIG. 2A, the Gaussian distribution is represented by a spot as shown in a white circle in each image (e.g., in heatmap 244a, 244b, or 244c) within the set of output images (e.g., the set of heatmaps 244). The size of the spot can be determined empirically. In at least one embodiment, the size of the spot can be scaled in line with the precision required in the task.

It will be noted that other distributions including the Gaussian distribution can be used or learned to represent the probabilities of the gripper position.

In at least one embodiment, the model 200 applies an additional filtering step to identify the probability distribution (e.g., the Gaussian distribution) and recover a grayscale heatmap. In one example, a convolution kernel with dimensions 1×1×1×D is created, where the dimensions correspond to width=1, height=1, output channels=1, and input channels=D. In the case of RGB images, the input channels can be defined as D=3. Then, a convolution process, using the convolution kernel, is performed on the output image (e.g., an output RGB image provided by the visual decoder 140), resulting in an output heatmap image of size H×W×1, where H and W are same height and width as the input image. The value at each pixel of the output heatmap image represents the extracted probability for that corresponding location. In at least one embodiment, the set of heatmaps corresponding to the set of views are aggregated into a single 3D heatmap of dimensions H×W×L, where H is height of the workspace in pixels, W is width of the workspace in pixels, and L is length of the workspace in pixels. In one example, the workspace is a cube where H=W=L. Finally, an argmax function (i.e., a mathematical operation that finds the location of the largest element within a collection of values) is applied on the 3D heatmap to extract the most likely gripper coordinates.

In at least one embodiment, the model 200 extracts a 3D position (p^{hm}) by solving the following optimization problem:

$${p}^{h m} = {arg max}_{p} {\prod }_{c = 1 , … , m} ( {H}^{c} [ C a m e raProjection ( p , {P}^{c} , {K}^{c} , {f}^{c} ) ] + ϵ ) , \qquad ( Eq . 9 )$$

where CameraProjection projects the 3D point p to 2D coordinates. The square brackets represent a 2D pixel-wise indexing operation with interpolation to support sub-pixel coordinates. ϵ is a small value (which can be tunable) added to allow decoding in situations where one of the heatmaps is zero for all 3D points.

Referring back to FIG. 2A, the position of the extracted 3D position (p^{hm}) is represented as a white dot within a white circle in each image (246a, 246b, or 246c) of the set of images 246. In at least one embodiment, the model 200 uses the 3D position (p^{hm}) to generate an end-effector keyframe indicating the predicted future state of the robot (or its end-effector). In at least one embodiment, the model 200 provides the set of images 246 indicating the extracted 3D position (p^{hm}) in the set of predefined (canonical) views as output (e.g., the end-effector keyframe) of the model 200.

In at least one embodiment, the LLM 130 and the visual decoder 140 (e.g., the image diffusion model therein) are trained end-to-end, so that they work together to produce consistent and effective predictions.

During training, the weights of the entire model 200 are first initialized, and then trained using a training dataset. In at least one embodiment, the weights of the visual encoder 120 (e.g., VisualEncoder) are frozen. The weights of the LLM 130, the input projector 220 (e.g., InputProjection), the output projector 230 (OutProjection), and the visual decoder 140 (e.g., ImageGenerator in the visual decoder) are tuned, allowing gradients to flow between these networks. Each training example includes a natural language instruction (l), visual observations {Iₖ, Dₖ, Pₖ, Kₖ}, and a ground truth gripper state label (ŝ). The input and output can be formatted using the same or different prompting scheme (e.g., maintaining the same prompt generator 134).

Experimentation shows that the system provided in the present disclosure (e.g., the model 200 trained using the aforementioned training scheme) outperforms prior art in terms of generalization to novel scenes, demonstrating less overfitting to the training scenes. Additionally, the system 100 with multi-task training appears to be less sensitive to the heatmap prediction mode (e.g., varying methods of generating heatmaps).

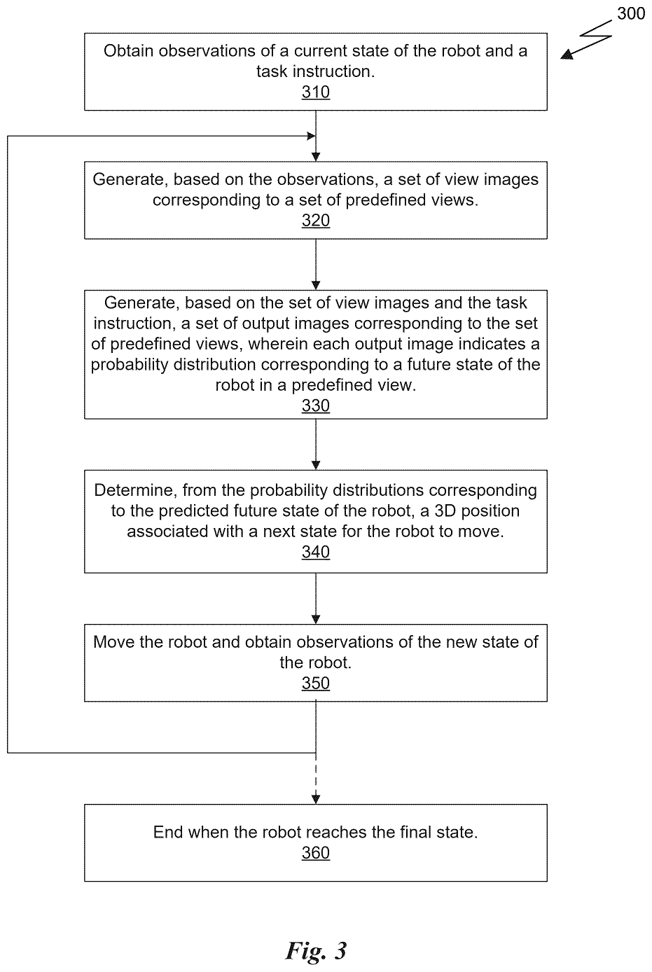

FIG. 3 illustrates a flowchart of a method 300 for controlling a robot to perform a task, in accordance with an embodiment. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At stage 310, the system 100 obtains observations of a current state of the robot and a task instruction. For example, the observations includes multiple images with color and/or depth information to capture the robot (or its end-effector) positioned in a working environment. The task instruction describes a robot manipulation task in natural language.

At stage 320, the system 100 generates, based on the observations, a set of view images corresponding to a set of predefined views. For example, the visual data renderer 110 reconstructs a 3D representation that combines the multiple images into a universal coordinate system and then generates the set of 2D view images based on this unified representation.

At stage 330, the system 100 generates, based on the set of view images and the task instruction, a set of output images corresponding to the set of predefined views. Each output image indicates a probability distribution corresponding to a future state of the robot in a predefined view. For example, each output image indicates a probability distribution of a location of the robot in a future state of the robot.

For example, the set of view images is encoded into sequences of visual tokens using the visual encoder 120, and a text token sequence is generated based on the task instruction, for example, utilizing the text encoder 132 and the prompt generator 134. Latent embeddings are generated based on the sequences of visual tokens and the sequence of text tokens. The LLM 130 receives the latent embeddings as input and predicts a set of action tokens. The sequence of action token is used to condition the visual decoder 140 for generating the set of output images (e.g., heatmaps) corresponding to the set of predefined views.

At stage 340, the system 100 determines, from the probability distributions corresponding to the predicted future state of the robot, a 3D position associated with the next state for the robot to move. For example, the system 100 extracts a 3D position (p^{hm}), as expressed by Equation 9, to determine the next position for the robot to move to.

At stage 350, the system 100 causes the robot to move to the predicted next state, and once completion, the system 100 obtains observations of the new state of the robot. For example, the system 100 provides an end-effector keyframe based on the next state determined from stage 340. As shown in FIG. 2B, a motion planner 150 can be used to determine a sequence of actions to move the robot from the current state to the predicted next state.

The system 100 repeats stages 320-350 until the robot completes the instructed task.

At stage 360, after one or more iterations, the system 100 ends the method 300 when the robot reaches the final state. The final state corresponds to the completion of the task as described in the task instruction.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

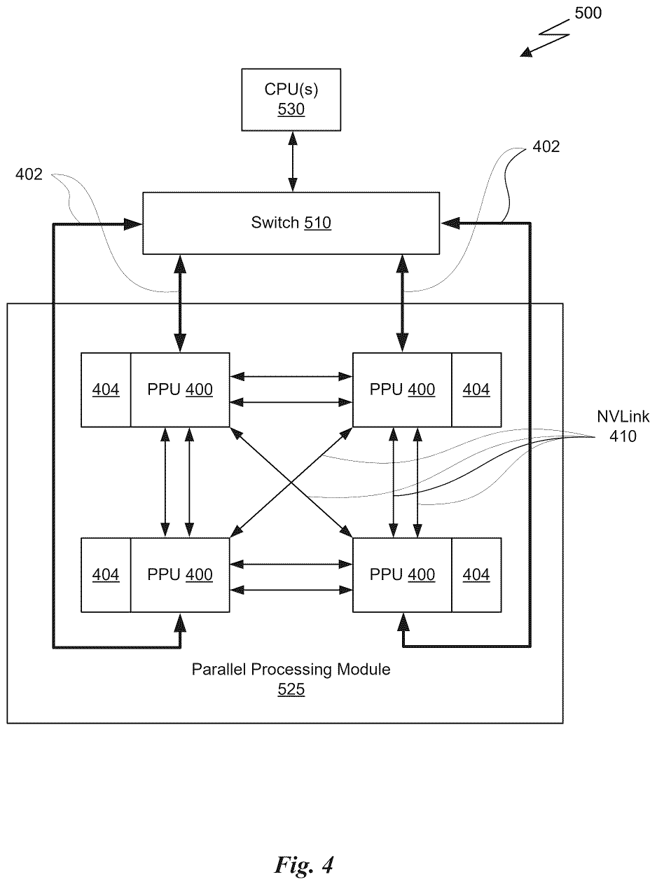

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

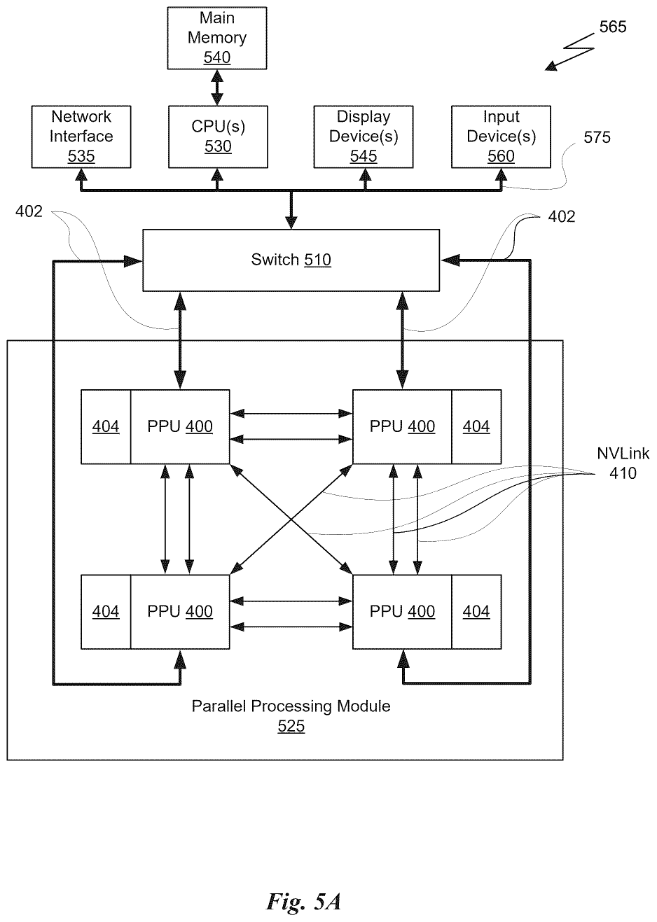

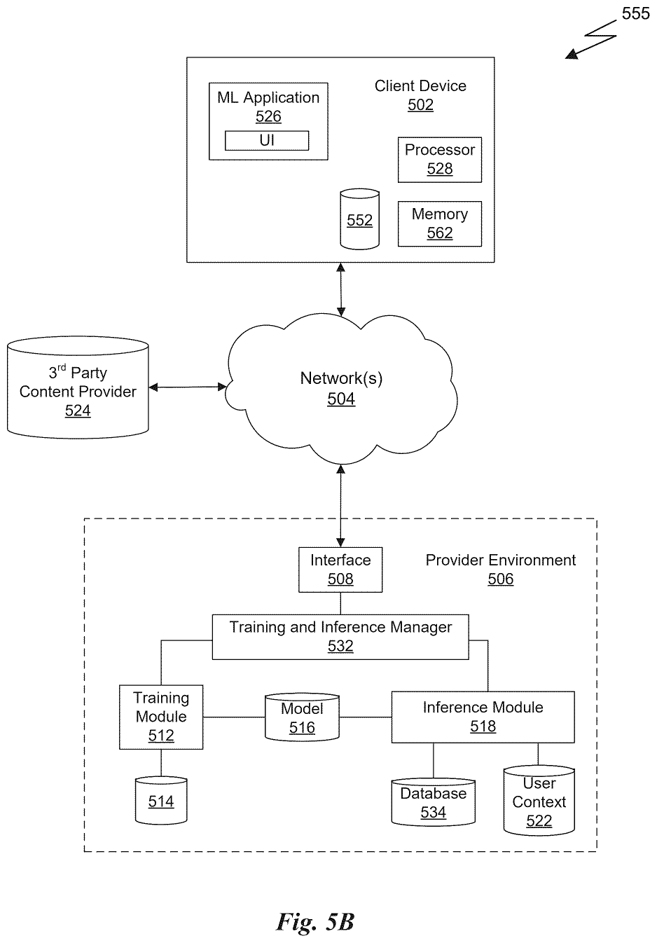

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

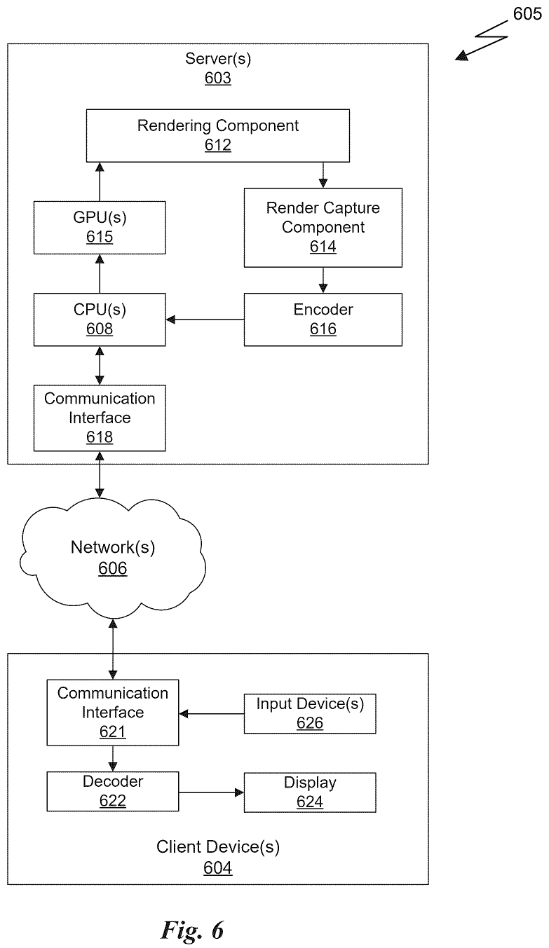

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for controlling a robot to execute a task, comprising:
generating, based on one or more view images and a text instruction describing the task, a plurality of input tokens, wherein each of the one or more view images corresponds to a predefined view of a set of predefined views;
generating, by a large language model (LLM) and based on the plurality of input tokens, a plurality of action tokens;
decoding the plurality of action tokens to generate one or more output images each corresponding to a predefined view of a set of predefined views, wherein the one or more output images indicate probability distributions of a location of the robot or an end-effector of the robot in a future state of the robot; and
determining, based on the probability distributions of the location of the robot or the end-effector in the future state of the robot, a three-dimensional (3D) position corresponding to the future state of the robot.

2. The computer-implemented method of claim 1, further comprising:
obtaining a plurality of input images based on observations of a scene; and
obtaining, based on the plurality of input images, the one or more view images.

3. The computer-implemented method of claim 2, further comprising:
generating a 3D reconstruction of the scene by combining the plurality of input images according to a universal coordinate system,
wherein the plurality of input images comprises one or more depth images, and
wherein the set of view images are two-dimensional (2D) images rendered from a 3D scene reconstruction.

4. The computer-implemented method of claim 3, wherein the 3D reconstruction of the scene comprises a point cloud.

5. The computer-implemented method of claim 1, wherein the determined 3D position is a position having the highest probability in 3D space obtained from the probability distributions.

6. The computer-implemented method of claim 1, wherein the set of predefined views are a set of canonical views obtained from a 3D representation of the scene.

7. The computer-implemented method of claim 1, further comprising:
generating, by one or more image encoders and based on the one or more view images, a set of image token sequences, each image token sequence corresponding to a predefined view of the set of predefined views, wherein each image token sequence comprises one or more image tokens; and
projecting, by one or more projection networks, the image token sequences to text embedding space,
wherein the plurality of input tokens comprises the set of image token sequences.

8. The computer-implemented method of claim 1, further comprising:
generating a prompt based on the text instruction describing the task; and
generating a sequence of text tokens based on the prompt,
wherein the plurality of input tokens comprises the sequence of text tokens.

9. The computer-implemented method of claim 1, further comprising:
generating, based on the plurality of action tokens and by one or more image decoders, one or more heatmaps as the one or more output images, wherein each heatmap indicates a probability distribution of a location of the robot or the end-effector in the future state of the robot in the corresponding predefined view;
combining the one or more heatmaps corresponding to the set of predefined views to produce an aggregated heatmap; and
determining, based on the aggregated heatmap, a 3D position with the highest probability in a 3D space as the 3D position corresponding to the future state.

10. The computer-implemented method of claim 1, further comprising:
moving the robot to the future state;
generating, based on one or more second view images and the text instruction describing the task, a plurality of second input tokens, wherein each of the one or more second view images corresponds to a predefined view of a set of predefined views;
generating, by the LLM and based on the plurality of second input tokens, a plurality of second action tokens;
decoding the plurality of second action tokens to generate one or more second output images each corresponding to a predefined view of the set of predefined views, wherein the one or more second output images indicate second probability distributions of a location of the robot or the end-effector in a second future state of the robot; and
determining, based on the second probability distributions of the location of the robot or the end-effector in the second future state of the robot, a second 3D position corresponding to the second future state of the robot.

11. The computer-implemented method of claim 1, further comprising:
during training, tuning a plurality of weights in the LLM and one or more visual decoders jointly, wherein weights in one or more visual encoders are frozen.

12. A system for controlling a robot to execute a task, comprising:
one or more processors configured to:
generate, based on one or more view images and a text instruction describing the task, a plurality of input tokens, wherein each of the one or more view images corresponds to a predefined view of a set of predefined views;
generate, by a large language model (LLM) and based on the plurality of input tokens, a plurality of action tokens;
decode the plurality of action tokens to generate one or more output images each corresponding to a predefined view of a set of predefined views, wherein the one or more output images indicate probability distributions of a location of the robot or an end-effector of the robot in a future state of the robot; and
determine, based on the probability distributions of the location of the robot or the end-effector in the future state of the robot, a three-dimensional (3D) position corresponding to the future state of the robot.

13. The system of claim 12, wherein the one or more processors are further configured to:
obtain a plurality of input images based on observations of a scene; and
obtain, based on the plurality of input images, the one or more view images.

14. The system of claim 13, wherein the one or more processors are configured to:
generate a three-dimensional (3D) reconstruction of the scene by combining the plurality of input images according to a universal coordinate system,
wherein the plurality of input images comprises one or more depth images, and
wherein the set of view images are two-dimensional (2D) images rendered from a 3D scene reconstruction.

15. The system of claim 14, wherein the 3D reconstruction of the scene comprises a point cloud.

16. The system of claim 12, wherein the determined 3D position is a position having the highest probability in 3D space obtained from the probability distributions.

17. The system of claim 12, wherein the set of predefined views are a set of canonical views obtained from a 3D representation of the scene.

18. The system of claim 12, wherein the one or more processors are further configured to:
generate, by one or more image encoders and based on the one or more view images, a set of image token sequences, each image token sequence corresponding to a predefined view of the set of predefined views, wherein each image token sequence comprises one or more image tokens; and
project, by one or more projection networks, the image token sequences to text embedding space,
wherein the plurality of input tokens comprises the set of image token sequences.

19. The system of claim 12, wherein the one or more processors are further configured to:
generate a prompt based on the text instruction describing the task; and
generate a sequence of text tokens based on the prompt,
wherein the plurality of input tokens comprises the sequence of text tokens.

20. The system of claim 12, wherein the one or more processors are further configured to:
generate, based on the plurality of action tokens and by one or more image decoders, one or more heatmaps as the one or more output images, wherein each heatmap indicates a probability distribution of a location of the robot or the end-effector in the future state of the robot in the corresponding predefined view;
combine the set of heatmaps corresponding to the set of predefined views to produce an aggregated heatmap; and
determine, based on the aggregated heatmap, a 3D position with the highest probability in a 3D space as the 3D position corresponding to the future state.

21. The system of claim 12, wherein the one or more processors are further configured to:
move the robot to the future state;
generate, based on one or more second view images and the text instruction describing the task, a plurality of second input tokens, wherein each of the one or more second view images corresponds to a predefined view of a set of predefined views;
generate, by the LLM and based on the plurality of second input tokens, a plurality of second action tokens;
decode the plurality of second action tokens to generate one or more second output images each corresponding to a predefined view of the set of predefined views, wherein the one or more second output images indicate second probability distributions of a location of the robot or the end-effector in a second future state of the robot; and
determine, based on the second probability distributions of the location of the robot or the end-effector in the second future state of the robot, a second 3D position corresponding to the second future state of the robot.

22. The system of claim 12, wherein the one or more processors are further configured to:
during training, tune a plurality of weights in the LLM and one or more visual decoders jointly, wherein weights in one or more visual encoders are frozen.

23. A non-transitory computer-readable media storing computer instructions for controlling a robot to execute a task that, when executed by one or more processors, cause the one or more processors to perform:
generating, based on one or more view images and a text instruction describing the task, a plurality of input tokens, wherein each of the one or more view images corresponds to a predefined view of a set of predefined views;
generating, by a large language model (LLM) and based on the plurality of input tokens, a plurality of action tokens;
decoding the plurality of action tokens to generate one or more output images each corresponding to a predefined view of a set of predefined views, wherein the one or more output image indicate probability distributions of a location of the robot or an end-effector of the robot in a future state of the robot; and
determining, based on the probability distributions of the location of the robot or the end-effector in the future state of the robot, a three-dimensional (3D) position corresponding to the future state to move the robot.

24. The non-transitory computer-readable media of claim 23, wherein the one or more processors further perform:
obtaining a plurality of input images based on observations of a scene; and
obtaining, based on the plurality of input images, the one or more view images.
